(19) United States
(12) Patent Application Publication
(10) Pub. No.: US 2006/0162234 A1
(43) Pub. Date: Jul. 27, 2006

(54) Magnetic fishing fly holder

(76) Inventor: John F. Gagnet, Cincinnati, OH (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 11/044,858

(22) Filed: Jan. 27, 2005

(51) Int. Cl. A01K 97/06

(52) U.S. Cl. 43/57.1; 43/54.1

(57) ABSTRACT

Disclosed is a magnetic holder for fishing flies in which the flies have a hook including a shank portion, a bend portion, and a point portion. The device includes a base having an upper surface and a lower surface. The upper surface has an array of hook receiving slots formed therein, each slot having a bottom surface, opposing side surfaces, and a substantially completely open top. Each slot has a width and depth sized to receive at least one of the point portion and the bend portion of a hook. At least one magnet is held by the base and positioned such that at least a portion of a surface of a magnet forms at least a portion of the bottom surface of each slot.

### TECHNICAL FIELD

This invention relates to a device for magnetically holding fishing flies in an organized manner. More specifically, it relates to a device which may be contained within a box which magnetically holds the metal hook portion of a fishing fly in an upright position.

### BACKGROUND OF THE INVENTION

To a fisherman, a collection of flies represents a substantial investment in time, money, or both, and is critical to the success or failure of the fishing endeavor. To a fish, a fly represents the entirely of whether to bite.

Because it is essential to have available a wide variety of flies from which to select, depending upon an endless number of variables, a wide variety of fly holders or boxes have been developed and offered in the past. Such prior devices include that shown in U.S. Pat. No. 6,516,555, issued Feb. 11, 2003 to Charles H. Buzzell. This reference shows a device for holding fly fish lures that has a number of elongated grooves with a side-mounted magnetic strip to hold the side of the fly hook. U.S. Pat. No. 1,993,144, issued Mar. 31, 1934 to Alfred S. Kasdan, shows a fly box with a series of parallel grooves and a series of separate bar magnets mounted below and parallel to each groove for magnetically holding a hook portion of each fishing fly. Each groove shown in this device is partially covered to form a chamber into which the point of each hook is inserted. As a result, the hook must be partially rotated for insertion and removal, creating risk that the barb of the hood will snag or that the effective length of each compartment may not correspond to the size of fishing hook being stored.

Despite numerous attempts to provide a suitable magnetic fly holder or box, there has remained a need for a device that is simple, light weight, inexpensive to manufacture, compact, and protects the substantial investment represented by a fisherman's collection of flies.

### SUMMARY OF THE INVENTION

The present invention provides a device for holding a plurality of fishing flies. The device provides an array of slots in a top surface of a base in which at least a portion of the bottom surface of each slot includes a surface portion of a magnet. A portion of the magnet is exposed at the bottom of each slot to contact and magnetically hold the point and/or a portion of the bend of each fly's hook.

The slots may be substantially parallel and positioned transverse to and above an elongated bar magnet. In such case, the bar magnet may be held in a slot or groove formed in a bottom surface of the base so as to present a surface of the magnet at the bottom of a series of slots.

Upright portions separating the slots provide support that prevents the fly from tipping and causing damage to the dressing of the fly. The slots may have closed ends that define the length of each transverse slot, but do not include any covering over any part of the slot that may interfere with insertion and/or removal of the fly's hook onto or from the magnet.

The array of slots may include more than one series of substantially parallel slots, each series intersecting with another series of slots. These intersecting series may be perpendicular or angled relative to one another. In such case, the magnets may be situated between intersecting slots or at the intersection of slots.

The presently described devices can be manufactured more economically than previous magnetic fly storage devices while providing far greater versatility.

### BRIEF DESCRIPTION OF THE DRAWINGS

Like reference numerals are used to represent like parts throughout various figures of the drawing, wherein:

FIG. 1 is a pictorial view of a magnetic fly holding device according to a first embodiment of the present invention with a surrounding box shown schematically in phantom line;

FIG. 2 is a side view of an embodiment of the device;

FIG. 3 is a top plan view of the device;

FIG. 4 is a cross-sectional view of the device taken substantially along line 4-4 of FIG. 2;

FIG. 5 is a fragmentary cross-sectional view of another embodiment of the device;

FIG. 6 is a pictorial view of yet another embodiment of the invention;

FIG. 7 is a sectional view thereof taken substantially along line 7-7 of FIG. 6;

FIG. 8 is a top plan view thereof; and;

FIG. 9 is a bottom plan view thereof with magnets removed for clarity.

### PREFERRED MODE FOR CARRYING OUT THE INVENTION

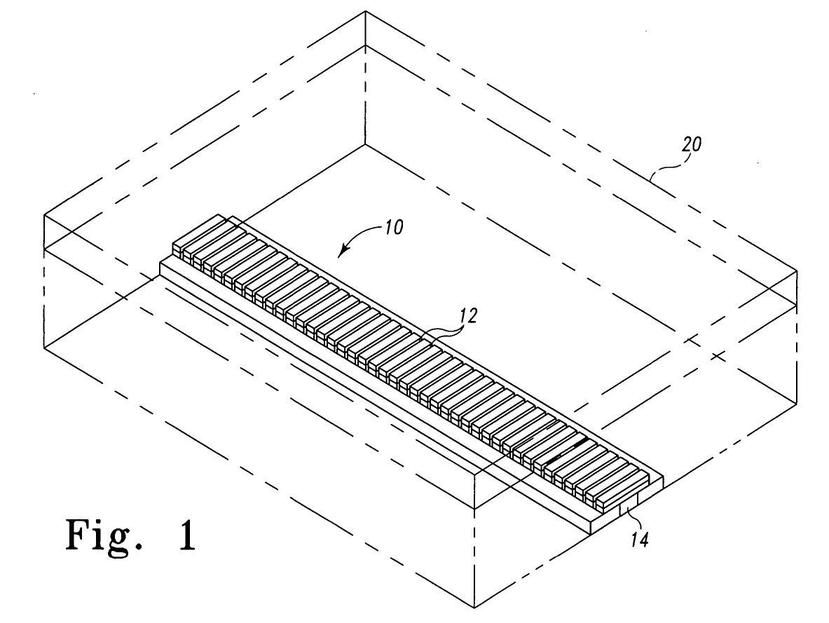

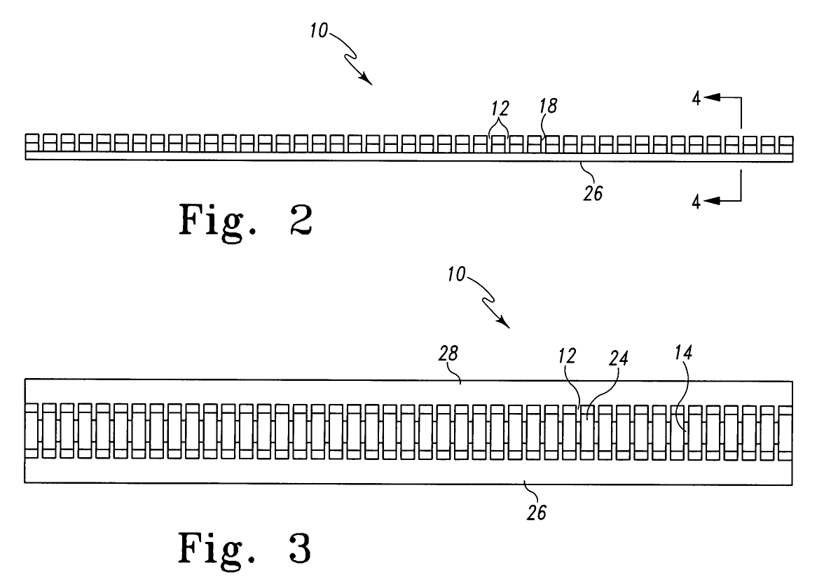

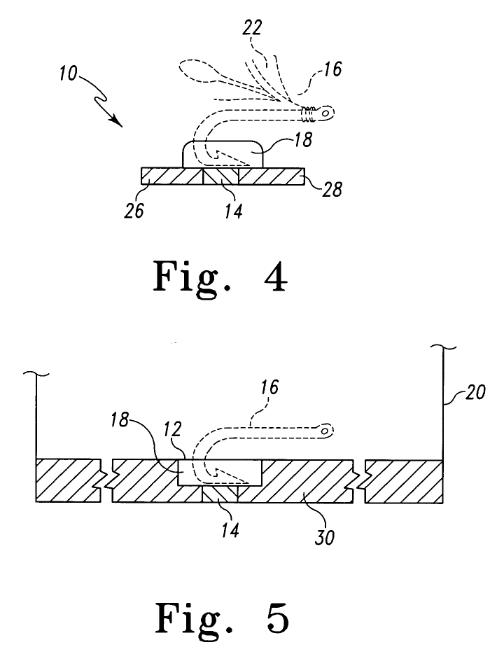

Referring to the various figures of the drawing, and first to FIGS. 1-4, therein is shown at 10 a magnetic fishing fly hook organizer according to a first embodiment of the present invention. The device 10 includes a longitudinal series of integral slots 12 transversely positioned over an elongated bar magnet 14. Fishing fly hooks 16 may be inserted into the slots 12 perpendicular to the length of the magnet 14 which secures the bottom edge of the hook 16 to the bottom of the slot 12 on the exposed surface of the magnet 14. The “bottom edge” of the hook 16, as used herein, is the outer radius of the point and associated portion of the bend of the hook 16. The hook 16 is prevented from tipping laterally, which would result in damaging the dressing portion 22 of the fly, by the sidewalls 18 of each slot 12. The sidewalls 18 are formed by the opposed faces of raised partitions 24 between each slot 12. The magnet 14 pulls the hook 16 into place and the hook 16 is easily displaced simply by lifting it out of the slot 12 by its shank. No rotation of the hook 16 or untangling of the barb is required for insertion or removal.

By providing a multitude of slots 12 along the length of the device 10, a wide variety of hook sizes and fly configurations can be accommodated and securely held in place without damage. If desired, the shanks of the hooks 16 can be alternated in direction along the length of the device 10. Mounting flanges 26, 28 may be provided along the length of the device 10 which both stabilize the device 10 and larger hooks 16 which may protrude beyond the ends of the partitions 24.

The construction of the present device 10 provides for economical manufacturing in several respects. First, a single bar magnet 14 can be used along the entire length of the device 10, rather than using separate magnets for each fly. Also, because the length of the magnet is perpendicular to the orientation of the fly hook 16 and a flat surface of the magnet is presented, a greater number of hooks can be stored in a smaller space without causing damage to the dressing 22 of each fly.

The device 10 can be formed by cutting from a single piece of wood or, preferably, molded from a single piece of plastic. When combined with a single bar magnet 14, the unit 10 provides a device that can be configured in either long or short lengths. The device 10 may be integrally formed in or mounted within a lidded box 20 or may be mounted with a clip or pin (not shown) for wearing on a vest or other outer clothing. The bar magnet 14 is held captive by either adhesive (not shown) or by attachment of the device body into the floor or lid of a box 20.

In one form, the lateral ends of each slot 12 are open. Alternatively, as shown in FIG. 5, the device may be formed, such as in a bottom 30 of a box 20, such that the slots 12 have closed ends. In either embodiment, however, there is no covering that extends over the point or barb of the hook 16 to complicate insertion or interfere with its ready removal. If desired, the slots 12 may be formed in varying widths to accommodate both large and small hook sizes.

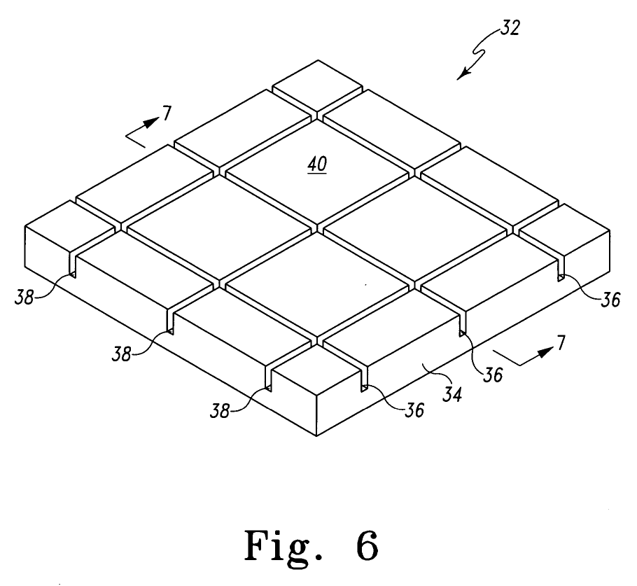

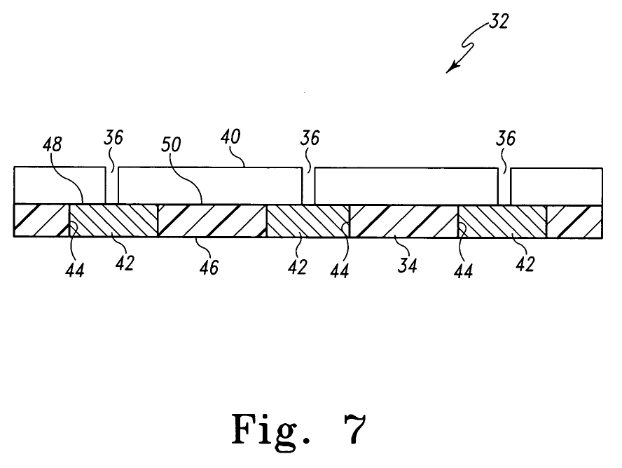

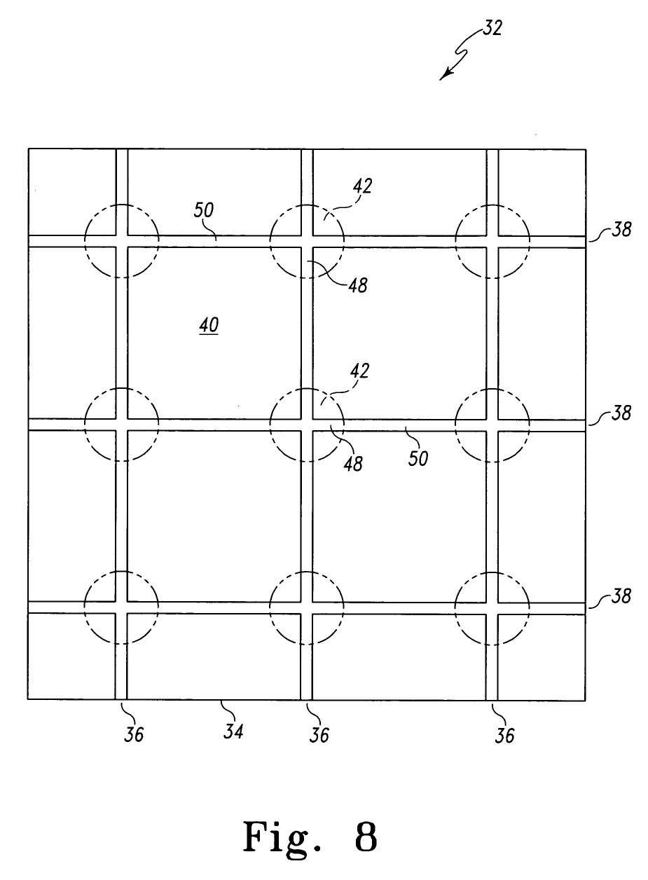

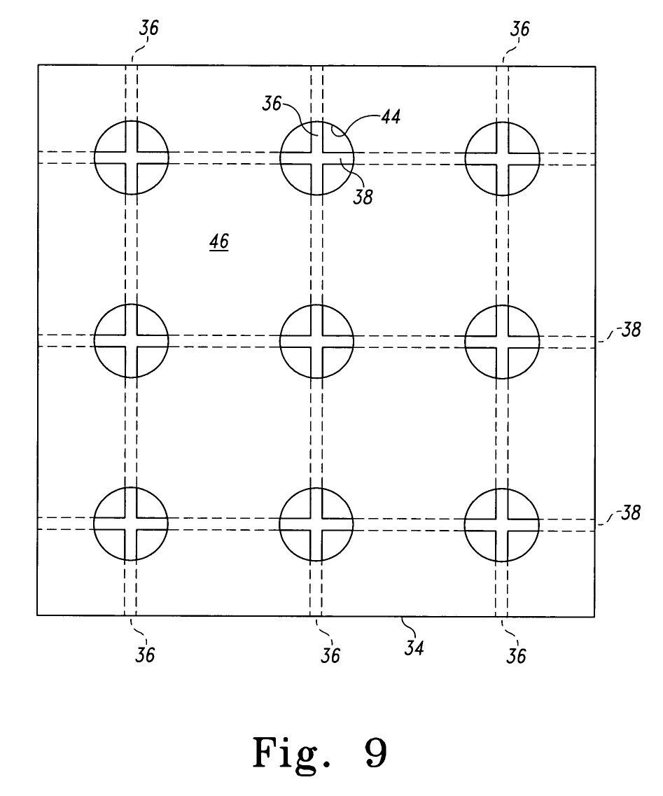

Referring now to FIGS. 6-9, therein is shown at 32 an alternate embodiment in which the base 34 includes two perpendicular series of substantially parallel slots 36, 38 formed in its upper surface 40. More than two series of substantially parallel slots could be used, if deemed desirable. In this embodiment, a plurality of separate magnets 42 are inserted in to openings 44 formed in the bottom surface 46 of the base 34. The magnets 42 can be round, for example, or any other shape deemed acceptable. Alternatively, elongated magnets (not shown in this embodiment) could be placed un bottom surface 46 grooves, such as diagonally, to intersect multiple slots 36, 38 or multiple series of slots.

The magnet-receiving bottom openings 44 can be sized to present a surface 48 of the magnet 42 that is substantially level with the bottom surface 50 of the slot 36, 38. The base may be sized to have any number of slots in a series, depending upon intended use, and a large sheet of base 34 material may be molded or otherwise formed and then cut to any desirable length and width.

Many other variation in my invention may be made without departing from the spirit thereof. Accordingly, the scope of my invention is defined only by the following claim or claims.

What is claimed is:

1. A magnetic holder for fishing flies having a hook including a shank portion, a bend portion, and a point portion, comprising:
a base having an upper surface and a lower surface;
said upper surface having an array of hook receiving slots formed therein, each slot having a bottom surface, opposing side surfaces, and a substantially completely open top, the slot having a width and depth sized to receive at least one of the point portion and the bend portion of a hook; and
at least one magnet held by the base and positioned such that at least a portion of a surface of a magnet forms at least a portion of the bottom surface of each slot.

2. The device of claim 1, wherein the array comprises a series of substantially parallel slots and the magnet is an elongated bar which extends substantially transverse to the slots and forms at least a portion of the bottom surface of multiple slots.

3. The device of claim 2, wherein the lower surface includes a magnet receiving slot formed to intersect multiple hook receiving slots substantially at the bottom surface.

4. The device of claim 1, wherein the array comprises at least two series of substantially parallel slots, each series of slots intersecting with another and wherein a plurality of magnets are positioned such that each forms at least a portion of the bottom surface of each slot.

5. The device of claim 4, wherein said magnet is positioned between intersecting slots.

6. The device of claim 4, wherein said magnet is positioned substantially at each intersection of slots such that a portion of each magnet forms a bottom portion of each of the intersecting slots.
